(19) United States
(12) Patent Application Publication
(10) Pub. No.: US 2004/0264679 A1
(43) Pub. Date: Dec. 30, 2004

(54) Partial redial for telephony systems

(76) Inventor: Steve Dobler, Stanhope, NJ (US)

Correspondence Address: BUCKLEY, MASCHOFF, TALWALKAR LLC, 5 ELM STREET, NEW CANAAN, CT, 06840, US

(21) Appl. No.: 10/609,704

(22) Filed: Jun. 30, 2003

(51) Int. Cl. H04M 1/00; H04M 3/00

(52) U.S. Cl. 379/355.01; 379/355.02

(57) ABSTRACT

A method, apparatus, and system for partial redial in a telephony system.

### BACKGROUND

In certain telephony systems, such as those coupled to a public switched telephone system (PSTN), each number entered in a device, such as a telephone, coupled to the PSTN is transmitted to the PSTN as it is entered. If an improper digit is entered in a user telephone, the user will typically end that session or “hang up” the telephone and begin entering digits again from the beginning.

### BRIEF DESCRIPTION OF THE DRAWINGS

The accompanying drawings, wherein like reference numerals are employed to designate like components, are included to provide a further understanding of the present partial redial techniques, are incorporated in and constitute a part of this specification, and illustrate embodiments of partial redial techniques that together with the description serve to explain the principles of the present partial redial techniques.

In the drawings:

FIG. 1 is a block diagram of a telephony network suitable for practicing an embodiment of partial redial;

FIG. 2 is a device suitable for practicing an embodiment of partial redial;

FIG. 3 is a block diagram of a device suitable for practicing an embodiment of partial redial; and

FIG. 4 illustrates a method of utilizing a telephone incorporating an embodiment of partial redial.

### DETAILED DESCRIPTION

Reference will now be made to preferred embodiments of the present partial redial techniques, examples of which are illustrated in the accompanying drawings. Moreover, those of ordinary skill in the art will appreciate that the partial redial techniques described in connection with a telephone handset in which numbers are entered manually by a user may be equally applicable to other telephones including, for example, automatic dial telephones. Other details, features, and advantages of the partial redial techniques will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

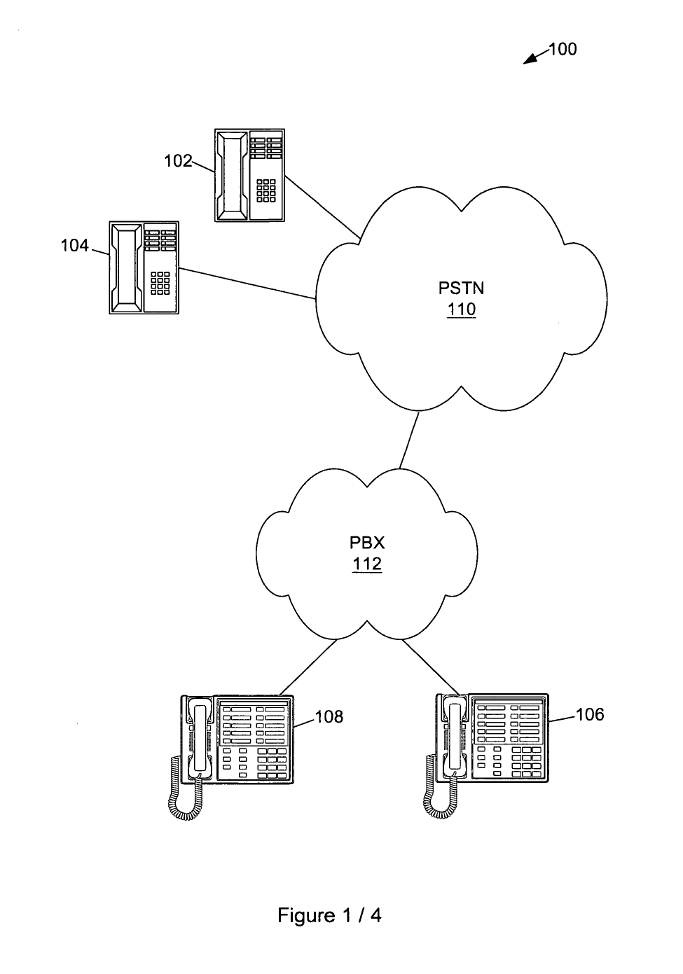

FIG. 1 illustrates an embodiment of the partial redial techniques in which four telephony devices 102, 104, 106, and 108 are coupled to a PSTN 110 to form a telephony network 100. The PSTN may be a collection of telephony networks operated, for the most part, by telephone companies and administrative organizations. Two of the telephony devices 106 and 108 are coupled to the PSTN through a private branch exchange 112 (PBX). The PBX is a telephone system, typically within an enterprise, that switches calls between telephony devices coupled to the PBX and phone lines coupled to the PSTN. A typical PBX includes several interface circuits that are coupled to telephony devices and several interface circuits that are coupled to a PSTN. A switching portion of the PBX makes connections between the telephony devices coupled to the PBX and other telephony devices coupled to the PBX or the PSTN. The present partial redial techniques may be utilized in connection either with telephony devices coupled directly to a PSTN or telephony devices coupled directly to a PBX.

Telephony devices that include partial redial may be, for example, telephones that are wired to a PBX or PSTN, wireless or cordless telephones, two-way radios, or other telephones that transmit digits as they are entered. Cordless telephones may include a telephone handset that communicates with a remote base station coupled to a PBX or PSTN, for example, by way of signals carried by radio waves. Such cordless telephones may include a radio-frequency transceiver and an omnidirectional antenna to couple to the radio-frequency transceiver.

In such a network 100, a telephone 102-108 coupled either directly to the PSTN 110 or coupled to the PSTN 110 through a PBX 112 may, by use of a partial redial facility, terminate a call originating from the telephone 102-108, establish a new connection with the PSTN 110 (a station to trunk call), and transmit fewer than all of the characters entered during the previous call. In addition, a telephone 106 that is utilized to place a call to another telephone 108 that is also coupled to the same PBX 112 (a station to station call) may incorporate a partial redial unit. In such a station to station calling situation, the partial redial unit may similarly terminate a call originating from the telephone 106, establish a new connection with the PBX 112, and transmit fewer than all of the characters entered during the previous call.

In an embodiment, a telephone redialing device is contemplated. That telephone redialing device includes a storage device that retains characters entered into a telephone when a call is being placed and a redial module to terminate a current call, establish a connection with a telephone network, and transmit fewer than all of the characters stored in the storage device. The telephone network may be any telephone network such as, for example, a PSTN or a PBX. The characters may, furthermore, be numbers representing a phone number that is desired to be reached.

The storage device may be memory, for example, and may retain only the characters entered during the last call from the telephone coupled to the redialing device, deleting all previously dialed characters, for example, when a call has been completed or when the telephone is taken off-hook. In that way, the characters redialed by the redialing device include only those numbers dialed in the most recent call.

The number of characters redialed by the redial device or the selection of characters not to be redialed by the redial device may vary. For example, in an embodiment, all but the last character entered are redialed by the redial device after it has terminated a call and reestablished another call. That embodiment assumes that a call is terminated immediately after a first improper character is entered. In such an embodiment, the redial device may be activated multiple times to repeatedly remove last characters entered.

An article of manufacture is also contemplated. In an embodiment, that article of manufacture includes a computer readable medium having stored thereon instructions. When the instructions are executed by the processor, the processor terminates a first telephone call, initiates a second telephone call, and retransmits signals representing fewer than all of one or more characters transmitted during the first phone call. That functionality performed by the processor may alternately be performed by a circuit such as, for example, a circuit specifically arranged to perform those functions.

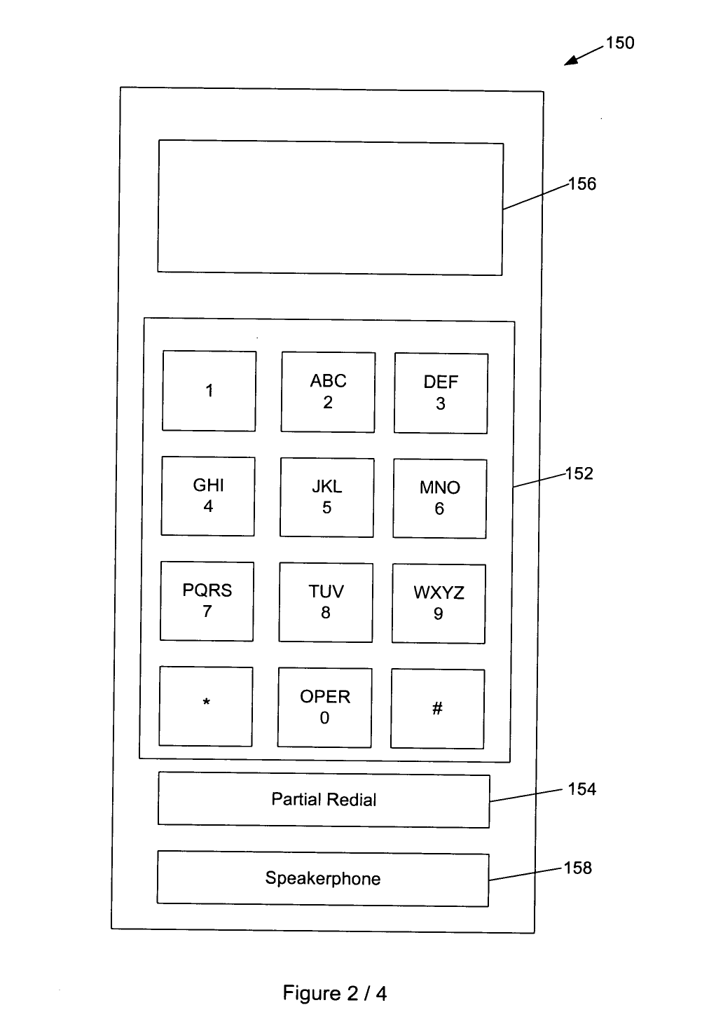

FIG. 2 illustrates a telephone device 150 that includes a partial redial button. The telephone includes a keypad 152 having standard function buttons for entering 0-9, *, and #, as well as a “partial redial” button 154. The buttons on the keypad 152 may communicate signals representing the character with which they are associated to a telephone system. Those signals may include pulse dialing signals as, for example, may be used in a rotary dialing system, or a tones such as DTMF tones used in a tone based dialing system. A telephone used with the partial redial techniques may include other buttons in addition to those buttons shown in FIG. 2, may include fewer buttons that illustrated in FIG. 2, and may include a call entry apparatus other than buttons such as, for example, a rotary dialing apparatus. Utilizing the telephone device 150 illustrated in FIG. 2, a user may press buttons on the keypad 152 associated with the phone number the user desires to contact in the appropriate order. Alternately, a device such as an automated dialer or a speech recognition device that dials characters may enter the appropriate numbers or characters. For example, a speech recognition device may transmit characters or digits as they are spoken and those characters might be displayed on a display as they are received. If a mistaken character is entered, then the speaker might say, for example, “partial redial” at which point the telephone might end the transmission, begin a new transmission, and retransmit all but the last digit. The telephone could then prompt the user to speak the remaining characters to complete the desired call.

A display 156 may be included with the telephone 150, although the invention may also operate without a display. A speakerphone button 158 may be included with the telephone 150, although the invention may also operate without a speakerphone. Telephones incorporating separate handsets and headsets may also be utilized in connection with the partial redial system, apparatus, and method.

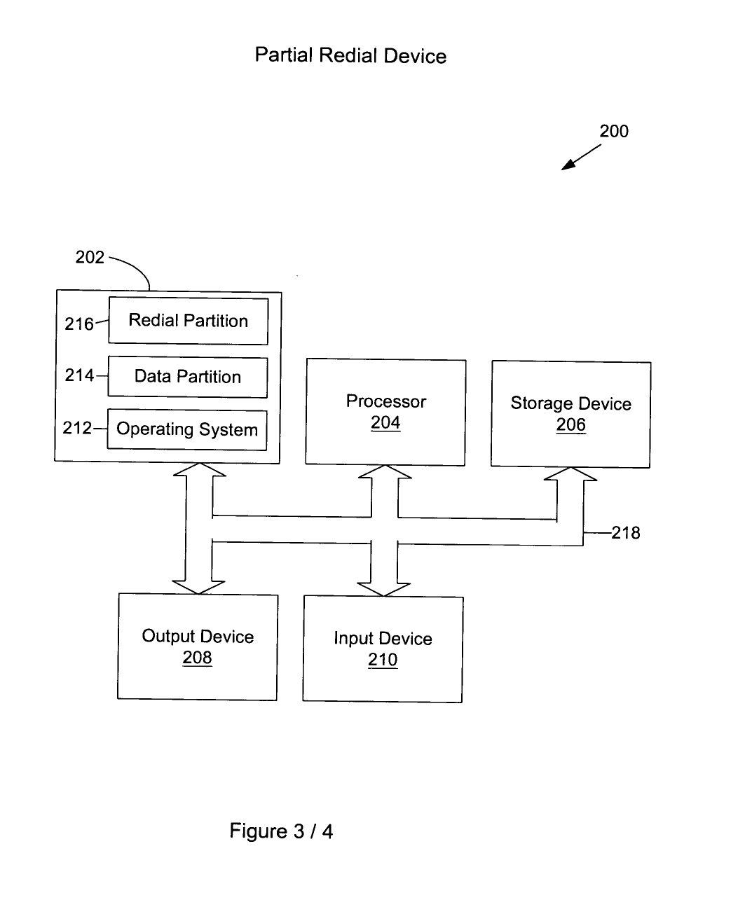

FIG. 3 illustrates a partial redial device 200. In an embodiment, the partial redial circuit may include memory 202, and a processor 204. The partial redial device 200 may also include a storage device 206, an output device 208, an input device 210, and other devices desired.

The memory 202 may, for example, include random access memory (RAM), dynamic RAM, and/or read only memory (ROM) (e.g., programmable ROM, erasable programmable ROM, or electronically erasable programmable ROM) and may store computer program instructions or information. The memory may furthermore be partitioned into sections including an operating system partition in which operating system 212 instructions are stored, a data partition 214 in which data is stored such as characters entered into a telephone coupled to the partial redial device 200, and a redial partition 216 in which instructions for performing redial functions are stored. The redial partition 216 may store program instructions and allow execution by the processor 204 of the program instructions. The data partition 214 may furthermore store data to be used during the execution of the program instructions.

The processor 204 may be, for example, an Intel® Pentium® type processor or the like, although the scope of the invention is not limited in this respect. The processor 204 may furthermore execute the program instructions and process the data stored in the memory 202. In one embodiment, the instructions are stored in memory 202 in a compressed and/or encrypted format. As used herein the phrase, “executed by a processor” is intended to encompass instructions stored in a compressed and/or encrypted format, as well as instructions that may be compiled or installed by an installer before being executed by the processor 204.

The storage device 206 may, for example, be a magnetic disk (e.g., floppy disk and hard drive), optical disk (e.g., CD-ROM) or any other device or signal that can store digital information including, for example, characters entered into a telephone coupled to the partial redial device 200.

The partial redial device 200 may also be coupled to one or more output devices 208 such as, for example, a display such as the telephone display 156 illustrated in FIG. 2, and input devices 210 such as, for example, buttons representing characters on the keypad 152 and a partial redial button 154, as illustrated in FIG. 2. It will be recognized, however, that the partial redial device 200 does not necessarily need to have any input device 210 or any output device 208 to operate. Moreover, the storage device 206 may also not be necessary for operation of the partial redial device 200.

The elements 202, 204, 206, 208, and 210 of the partial redial device 200 may communicate by way of one or more communication busses 218. Those busses 218 may include, for example, a system bus, a peripheral component interface bus, and an industry standard architecture bus.

When utilizing a telephone, a user typically connects to a telephone line by, for example, picking up a receiver or pressing a speakerphone button. When the telephone is coupled to a PBX, the PBX makes a connection between an interface circuit in the telephone and a circuit of the PSTN, typically through a Central Office portion of the PSTN. The Central Office typically provides a link between audio switching equipment and a telephone line. The PBX then takes the circuit “off-hook,” coupling the telephone to the Central Office, which then typically provides a dial tone to the telephone.

The user may then enter a character, typically a number, and that character is transmitted to the Central Office. If the telephone has a display, that character may also be displayed thereon. The Central Office will typically stop sending the dial tone once it receives the first character. The user then continues to enter characters with each character being transmitted to the Central Office immediately after being pressed or dialed, and showing on the display where such a display is available on the telephone. Once all characters have been entered, a ring back tone is typically generated by the Central Office, the person being called answers the phone, and the Central Office connects the calling telephone to the receiving telephone.

Because each character is transmitted to the Central Office immediately after being pressed or dialed, if an incorrect character is entered, then the caller typically must terminate the call by, for example, hanging up the telephone, and begin the calling process again. By utilizing a partial redial feature, however, the user may automatically terminate the call, establish a connection with a telephone network, whether PSTN or PBX, and re-transmit fewer than all of the characters previously entered.

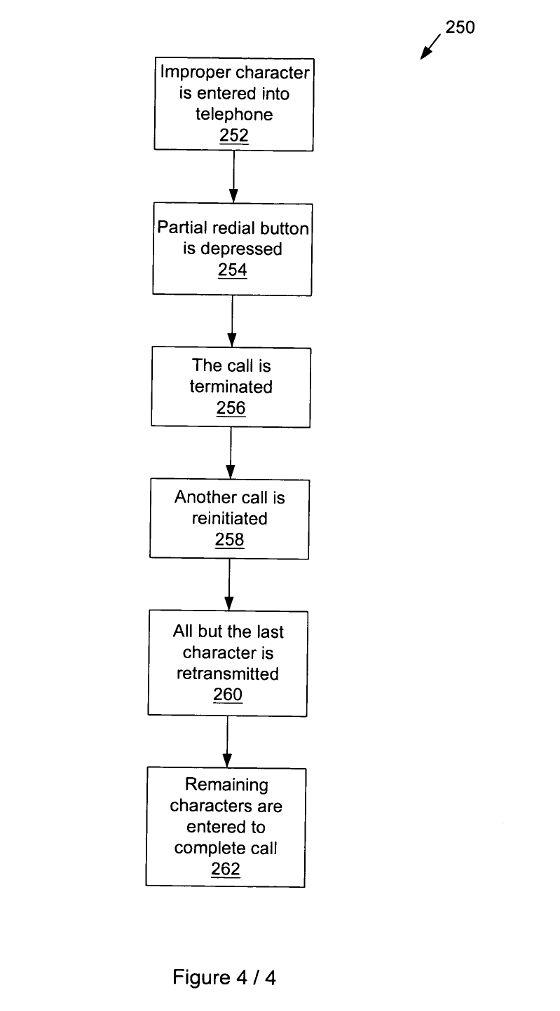

FIG. 4 illustrates a method of utilizing a telephone incorporating an embodiment of partial redial 250. The partial redial method 250 assumes that the user is utilizing a telephone such as that illustrated in FIG. 2, having a partial redial button 154 although a differently configured device could alternately be used to achieve similar results. At 252, an improper character is entered into the telephones 50. At 254, the partial redial button is depressed by the user of the telephone 150 to initiate the partial redial operation. It should be noted that the partial redial operation could be actuated by other than pressing a button, such as, for example, automatic actuation by a circuit or computerized device. At 256, in response to actuation of the partial redial function, the call is terminated, and at 258, another call is reinitiated by, for example, taking the line off-hook. At 260, all but the last character entered in the previous call are retransmitted. Where a display is utilized, such as the display 156 of FIG. 2, the display may display the characters or numbers originally entered on an upper line, and display the characters redialed after partial redial was initiated on a lower line. Once partial redial has finished redialing the characters that it is to redial, the display may prompt the user to enter the remaining characters by displaying, for example a message stating “Please Continue Dialing.” Where an audible alert is available, that audible alert may be sounded alternately or as well to indicate to the user to continue entering the remaining characters. The user or an automated device may then enter the remaining characters desired at 262 to complete the desired call.

When the characters are retransmitted, all but the last character entered may be retransmitted, assuming that the mistaken character was the last character entered. In an embodiment wherein all but the last character entered is retransmitted, and the user entered an improper character prior to the last character entered, the user may operate the partial redial one or more additional times to back up an additional character by, for example, pressing a partial redial button on the telephone repeatedly.

While the systems, apparatuses, and methods of partial redial have been described in detail and with reference to specific embodiments thereof, it will be apparent to one skilled in the art that various changes and modifications can be made therein without departing from the spirit and scope thereof. Thus, it is intended that the partial redial cover modifications and variations provided they come within the scope of the appended claims and their equivalents.

What is claimed is:

1. A telephone redialing device, comprising:
a storage device that retains characters entered into a telephone when a call is being placed; and
a redial module to terminate a current call, establish a connection with a telephone network, and transmit fewer than all of the characters stored in the storage device.

2. The telephone redialing device of claim 1, wherein the telephone network is a public switched telephone network.

3. The telephone redialing device of claim 1, wherein the telephone network is a private branch exchange.

4. The telephone redialing device of claim 1, wherein the characters entered into the storage device are removed from the storage device prior to placing a new call.

5. The telephone redialing device of claim 1, wherein the redial module transmits all of the characters stored in the storage device except the last character stored in the storage device.

6. The telephone redialing device of claim 5, wherein the redial module is activated second time, thereby transmitting all but the last two characters entered.

7. The telephone redialing device of claim 1, wherein the storage device is memory.

8. The telephone redialing device of claim 1, wherein the redial module is initiated by a user pressing a partial redial button coupled to the redial module.

9. The telephone redialing device of claim 1, wherein the characters include numbers representing a phone number to be contacted.

10. A telephone, comprising:
a radio-frequency transceiver;
an omnidirectional antenna to couple to said radio-frequency transceiver; and
a partial redial unit to cause a public branch exchange to terminate a call, establish a connection, and transmit at least one fewer characters than a number of characters previously transmitted.

11. The telephone system of claim 10, wherein the characters previously transmitted were characters entered by a user of the telephone.

12. The telephone system of claim 10, wherein the partial redial unit includes a storage device to store characters entered into the telephone, and wherein the characters entered into the storage device are removed from the storage device prior to placing a new call.

13. The telephone system of claim 12, wherein the partial redial unit transmits all of the characters stored in the storage device except the last character stored in the storage device.

14. The telephone system of claim 10, wherein the characters include numbers representing a phone number to be contacted.

15. A telephone, comprising
a keypad having buttons that communicate signals representing numbers 0 through 9 to a telephone system and a partial redial button; and
a partial redial unit to retain signals entered into the keypad during a previous call, terminate that call, establish a connection with the telephone network, and transmit fewer than all of the retained signals when actuated.

16. The telephone of claim 15, wherein the signals include a series of pulses that represent entered characters.

17. The telephone of claim 15, wherein the signals include tones that represent entered characters.

18. The telephone of claim 15, wherein the retained signals are no longer retained after a call has been completed.

19. The telephone redialing device of claim 15, wherein the partial redial unit transmits all of the retained signals except the last retained signal.

20. A method of reentering a telephone number, comprising:
initiating a first telephone call;
transmitting one or more numbers to a telephone system through a telephone;
actuating a partial redial unit that:
terminates the first telephone call;
initiates a second telephone call; and
retransmits fewer than all of the one or more numbers entered into the telephone; and
transmitting at least one additional number to the telephone system through the telephone.

21. The method of claim 20, further comprising displaying the transmitted numbers on a display.

22. The method of claim 20, further comprising prompting a user to transmit the at least one additional number after the retransmitting of fewer than all of the one or more numbers entered into the telephone is completed.

23. An article of manufacture, comprising:
a computer readable medium having stored thereon instructions which, when executed by a processor, cause the processor to:
terminate a first telephone call;
initiate a second telephone call; and
retransmit signals representing fewer than all of one or more characters transmitted during the first phone call.

24. The article of manufacture of claim 23, wherein the retransmitted characters are transmitted over a public switched telephone network.

25. The article of manufacture of claim 23, wherein the retransmitted characters are transmitted over a private branch exchange.

26. The article of manufacture of claim 23, wherein signals representing all but the last character transmitted are retransmitted.
